(19) United States
(12) Patent Application Publication
(10) Pub. No.: US 2021/0209274 A1
(43) Pub. Date: Jul. 8, 2021

(54) Method of designing the spiral vortex chambers of fuel mist atomizing device in gas turbine engines

(71) Applicant: VIETTEL GROUP, Ha Noi City (VN)

(72) Inventors: TIEU BINH DANG, Khoai Chau District (VN); DUY LANH CHU, Ha Noi City (VN); MINH TRI NGUYEN, Ha Noi City (VN); NHAT MINH HOANG, Ha Noi City (VN)

(73) Assignee: VIETTEL GROUP, Ha Noi City (VN)

(21) Appl. No.: 16/920,517

(22) Filed: Jul. 3, 2020

(30) Foreign Application Priority Data
Jan. 2, 2020 (VN) 1-2020-00039

(51) Int. Cl. G06F 30/28; G06F 30/23

(52) U.S. Cl. CPC G06F 30/28; G06F 2113/08; G06F 30/23

(57) ABSTRACT

A method of designing fuel mist atomizing device in gas turbine engines with spiral vortex chamber. The design method includes the following steps: step 1: determining the required information; step 2: designing, calculating and selecting geometrical dimension parameters of the mist atomizing device; Step 3: Generating 3D model of the mist atomizing device; Step 4: Performing design iteration and optimization.

### TECHNICAL AREAS ARE MENTIONED

This patent refers to the method of designing spiral vortex chambers of fuel mist atomizing devices in gas turbine engines. Specifically, the method of designing a spiral vortex chambers of fuel mist atomizing device in a combustion chamber of a gas turbine engine is extensively used in the aerospace, power generator, submarines, ships, security and defense.

### PATENT TECHNICAL STATUS

The fuel mist atomizing device is one of the most important components in the combustion chamber of a gas turbine engine, generating fuel mist under high pressure in the engine combustion chamber, making it able to ignite the mixture of compressed air and fuel mist. The structure of the fuel mist atomizing device consists of two main parts: the spiral vortex chamber and the outlet of fuel mist atomizing device. The form and parameters of the spiral vortex chamber play a decisive role in the performance and quality of the equipment.

There have been many studies on fuel mist atomizing devices of gas turbine engines, but these are all undisclosed secrets. This patent proposes a method of designing a spiral vortex chamber to ensure the functionality and working quality of the fuel mist atomizing device in gas turbine engines.

### PATENT TECHNICAL NATURE

With the above patent technical status, the purpose of the present patent is to propose a method of designing a spiral vortex chamber of a fuel mist atomizing device in gas turbine engines.

The design method includes the following steps: step 1: determining the necessary information (spray angle and size of fuel particles); step 2: designing, calculating and selecting spatial dimension parameters of fuel fogging device; Step 3: building 3D model of fuel mist atomizing device, adjusting designs taking into account manufacturing and processing capabilities; step 4: performing design loop, optimize the design.

In this patent, the entire calculation process is performed on the computer system with built-in software needed for calculation.

### BRIEF DESCRIPTION OF THE FIGURES

FIG. 1: Illustration of the working process of fuel mist atomizing device with fuel entering the spiral vortex chamber in the axial direction;

FIG. 2: Illustration of the working process of fuel fogging device with fuel entering the spiral vortex chamber in the radial direction;

FIG. 3: Illustration the design of spiral vortex chamber;

FIG. 4: Diagram showcases the steps of designing a spiral vortex chamber of fuel mist atomizing device in gas turbine engine.

### DETAILED DESCRIPTION

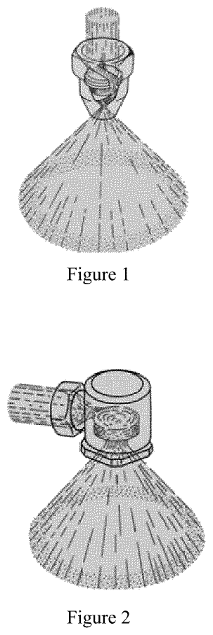

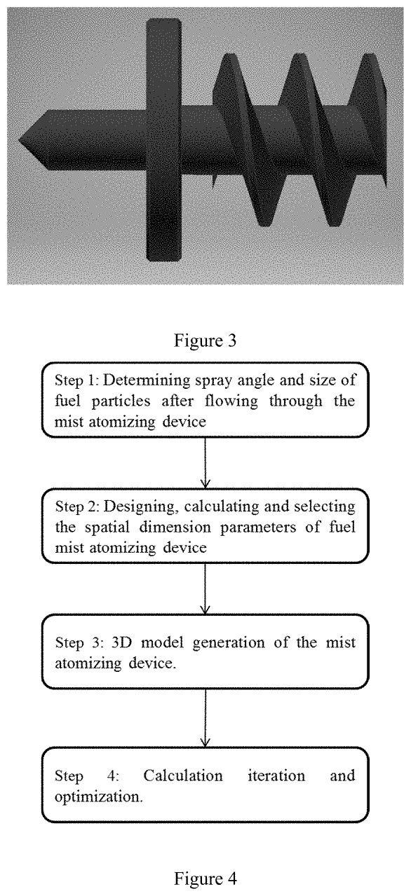

Referring to FIG. 1, FIG. 2, FIG. 3 and FIG. 4, the following describes the process of designing the spiral vortex chamber of fuel mist atomizing device in the gas turbine engine.

Technical Requirements:
The size of the fuel particle after leaving the device must be smooth enough (smaller than 100 microns).
Wide spray angle for homogeneous mixture.
The fineness of fuel particles is calculated by the formula:

$$D = 4 , 4 \cdot {σ}^{0 , 6} \cdot {( \frac{μ}{ρ} )}^{0 , 16} \cdot {m}^{0 , 22} \cdot Δ {P}^{- 0 , 43} \qquad ( 1 )$$

With, D—Average particles diameter after leaving the fuel mist atomizing device, μm,

σ—Fuel viscosity, Pa·s,

ρ—Fuel density, kg/m³,

m—Fuel volume flow rate, m3/s,

μ—Flow coefficient of the mist atomizing device,

ΔP—Pressure loss of the mist atomizing device.

The method of designing a spiral vortex chamber of fuel mist atomizing device is implemented through equations, programs, and calculation software: Mathcad, Ansys. In order to achieve the accuracy and quality of the mist atomizing device, the design process is carried out by both analytical methods and finite element analysis.

Referring to FIG. 3 and FIG. 4, the steps of designing method are explained below:

Step 1: Determining spray angle and size of fuel particles after flowing through the mist atomizing device.

Each gas turbine engine requires different spray angle and particles size after flowing through the mist atomizing device after preliminary design stage.

Next, determining spray angle particles size and fuel pressure before the mist atomizing device.

Step 2: Designing, calculating and selecting the spatial dimension parameters of the fuel mist atomizing device.

Each value of inlet pressure of the mist atomizing device defines a characteristic parameter, called the fill factor (the ratio of fuel to fill out the outlet of the fogging device), affecting the spray angle of the outlet of mist atomizing device according to the following formula:

$$tan ( \frac{α}{2} ) = \frac{2 \sqrt{2} \cdot ( 1 - θ )}{\sqrt{θ} \cdot ( 1 + \sqrt{1 - θ} )} \qquad ( 2 )$$

Flow coefficient μ is calculated by the formula:

$$μ = θ \sqrt{\frac{θ}{2 - θ}} \qquad ( 3 )$$

$$μ = θ \sqrt{\frac{θ}{2 - θ}} \qquad ( 3 )$$

The area of the drainage hole area is calculated by the following formula:

$$A = \frac{m}{μ \sqrt{\frac{2}{ρ} Δ P}} \qquad ( 4 )$$

### With:

α—angle of fuel output injection,
μ—flow factor,
θ—fill factor,

From Eq.(1), (2), (3), (4), it can be seen if D, α are constant m, ΔP, A, d can be varied to achieve the geometrical parameters of the device, especially, the spiral vortex chamber. The design for manufacturing factor is also concerned during geometrical parameters selection process.

After entering the inlet of the mist atomizing device, the flow follows the designed spiral channel which exerts a centrifugal force of the flow before entrancing the spiral chamber and the outlet.

Step 3: 3D model generation of the mist atomizing device.

Based on the designed parameters that have been calculated in Step 2, the 3D model can be generated by any 3D mechanical design software or by using the Design Modeler tool in Ansys.

Step 4: Calculation iteration and optimization.

The generated 3D model is imported into aerodynamics or fluid mechanics software for the determination of flow coefficient. In this step, a number of parametric studies are analyzed among designed parameters. Based on the results from the parametric studies, the flow coefficient, form and geometric dimensions are determined. Based on the results of the simulation, Step 2 and Step 3 is iterated to optimize the flow parameters, spray angle, size of the outlet and regenerate the 3D model, then put in the simulation and iterate the process. The iteration stops until the optimum design is obtained.

1. The method of designing the spiral vortex chamber of a fuel mist atomizing device in a gas turbine engine comprising of the following four steps:
Step 1: Determining a spray angle and size of fuel particles after flowing through the fuel mist atomizing device; at this step, the determination of the spray angle, the size of fuel particles and a fuel pressure before entering the device is calculated after a preliminary design stage of the gas turbine engine with specialized design software, The obtained result includes a requirement for the pressure and geometrical dimension of a combustion chamber;
Step 2: Designing, calculating and selecting geometrical dimension parameters of fuel mist atomizing device; at this step, each inlet pressure of the fuel mist atomizing device determines a characteristic parameter called the fill factor (the ratio of fuel to fill an outlet of the mist atomizing), Based on the result of determining the fill factor, an outlet spray angle, flow coefficient and outlet area are determined;
Step 3: 3D model generating of the fuel mist atomizing device; After adequate parameters are obtained, most appropriate design plan for the material, form, spatial dimensions are selected which is used for generating 3D model;
Step 4: Performing design iteration and optimization; 3D model of the fuel mist atomizing device after is imported into aerodynamic and fluid mechanic simulation software to determine the flow coefficient; In this step, a number of parametric studies are analyzed among designed parameters, Based on the results from the parametric studies, the flow coefficient, form and geometric dimensions are determined.
